(19) United States
(12) Patent Application Publication
(10) Pub. No.: US 2005/0041389 A1
(43) Pub. Date: Feb. 24, 2005

(54) Computer assembly having a bulkhead component and bulkhead connectors for mating with storage drive connectors

(76) Inventors: Cynthia L. Martin, Olympia, WA (US); John C. Schwartz, Portland, OR (US); Billy K. Taylor, Columbia, SC (US)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/646,026

(22) Filed: Aug. 22, 2003

(51) Int. Cl. G06F 1/16

(52) U.S. Cl. 361/685

(57) ABSTRACT

A computer subassembly is provided. The provision of a bulkhead component and bulkhead connectors allows for storage drives to be replaced by simply removing a S-ATA storage drive and inserting another storage drive in its place. Furthermore, the bulkhead component requires no electric interconnection, as may be the case when an electronic backplane is used.

### BACKGROUND OF THE INVENTION

1). Field of the Invention

This invention relates generally to a computer assembly, and more specifically to the manner in which information storage drives of the computer assembly connect to corresponding connectors for purposes of providing logic communication between the storage drives and electronic board, and for purposes of providing power to the storage drives.

2). Discussion of Related Art

Information storage drives, such as hard disk drives, CD drives, etc., of a computer are usually connected to an electronic board, often a motherboard, for purposes of providing logic communication between the storage drives and the electronic board.

According to one conventional approach, a cable is connected between an electronic board and a first storage drive, and the storage drive is subsequently mounted on a support secured to a frame. Another cable is then connected between the first storage drive and a second storage drive, and the second storage drive is mounted to a support connected to the frame. The process may be repeated by connecting another cable between the second storage drive and a third storage drive, and mounting the third storage drive to another support. Whenever a storage drive has to be replaced, the entire system has to be switched off, the computer has to be opened, cables connected to the storage drive that has to be replaced have to be disconnected from behind the storage drive, whereafter the storage drive can be removed, another storage drive can be installed in its place, and the system can be switched on.

A computer system utilizing storage drives generally known as SCSI storage drives allows for replacement of storage drives without switching the system off, and also for replacement of storage drives without opening the computer. In such a system, a controller located on a backplane turns power to a specific storage drive off, and illuminates an LED to indicate which storage drive can be removed. The backplane is mounted to a frame and has a plurality of backplane connectors thereon that are connected to one another in series. Because the backplane and the backplane connectors are in a fixed relationship relative to the frame, SCSI storage drives can be inserted on supports, and drive connectors thereon can engage with the backplane connectors. An SCSI storage drive can be replaced by simply removing the SCSI storage drive from the front, without opening the computer system, and then locating another SCSI storage drive in its place. An SCSI system thus allows for “hot swapping” of storage drives. The backplane is connected to an electronic board through a ribbon cable, and a connector on the backplane connected to the ribbon cable is connected to a first of the backplane connectors. Subsequent ones of the backplane connectors are connected to one another in series.

Serial ATA (S-ATA) is a new technology that is lower in cost than SCSI technology, with similar performance. A S-ATA system has a plurality of S-ATA storage drives that are individually connected through separate cables to separate connectors on an electronic board. A S-ATA system does allow for replacement of S-ATA storage drives without switching the entire system off. However, a S-ATA storage drive does not have a backplane, such as in an SCSI system, so that the computer system has to be opened in order to connect/disconnect cables to/from the S-ATA storage drives.

### BRIEF DESCRIPTION OF THE DRAWINGS

The invention is described by way of example with reference to the accompanying drawings, wherein:

FIG. 1 is an elevational side view of a computer subassembly, according to an embodiment of the invention;

FIG. 2 is an end view of a bulkhead connector assembly that is used in the computer subassembly of FIG. 1;

FIG. 3 is a perspective view of the bulkhead connector assembly;

FIG. 4 is a top plan view of the bulkhead connector assembly when mounted to a bulkhead component of the computer subassembly; and

FIG. 5 is block diagram illustrating further components of a computer system which includes the subsystem of FIG. 1.

### DETAILED DESCRIPTION OF THE INVENTION

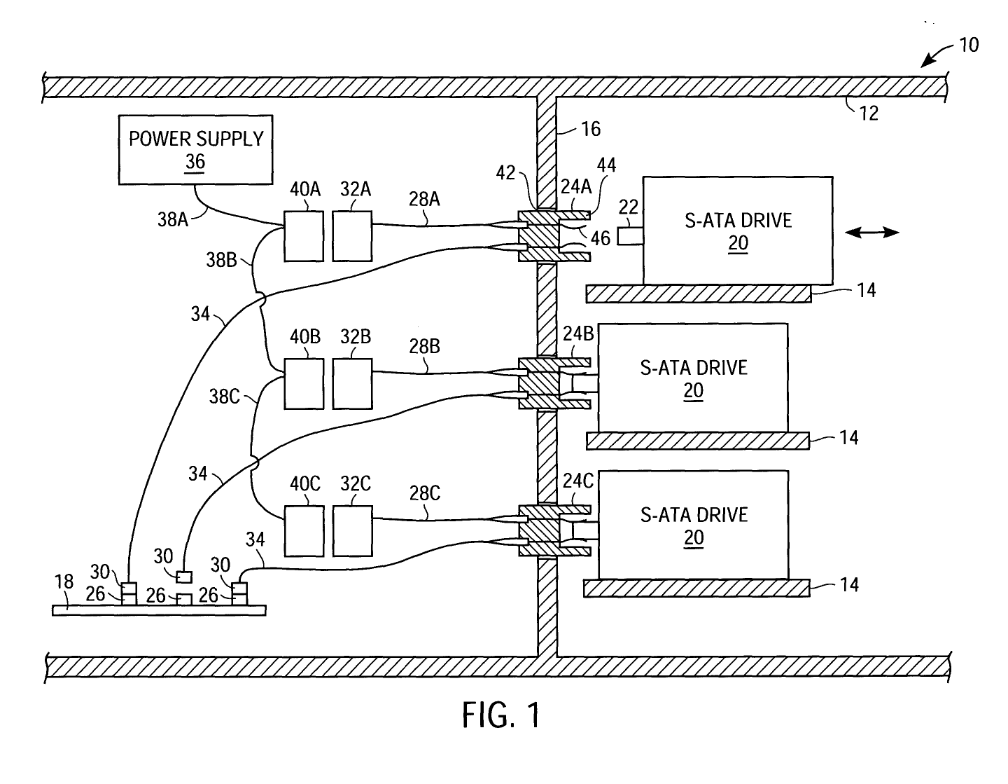

FIG. 1 of the accompanying drawings illustrates a computer subassembly 10 according to an embodiment of the invention. The computer subassembly 10 includes structural components such as a frame 12, a plurality of storage drive supports 14, and a bulkhead component 16. The computer subassembly 10 also includes an electronic board 18 and a plurality of information storage drives in the form of S-ATA storage drives 20. The computer subassembly 10 further includes electronic interconnection components, including a plurality of drive connectors 22, a plurality of bulkhead connectors 24, a plurality of board connectors 26, a plurality of signal connectors 30, and a plurality of flexible signal cables 34. The computer subassembly 10 further includes power components, including a power supply 36 and a plurality of power cables 38, a plurality of first power connectors 40, a plurality of second power connectors 32, and a plurality of flexible power lines 28. The provision of the bulkhead component 16 and the bulkhead connectors 24 allow for the S-ATA storage drives 20 to be replaced by simply removing a S-ATA storage drive 20 from left to right and inserting another S-ATA storage drive from the right to the left in its place. Furthermore, the bulkhead component 16 requires no electric interconnection, as may be the case when an electronic backplane is used. Each S-ATA storage drive 20 is individually connected to the electronic board 18 as mandated by S-ATA protocol.

The bulkhead component 16 is mounted to the frame 12 in a vertical orientation. The bulkhead component 16 has a plurality of connector openings 42 formed therein at spaced vertical locations. The storage drive supports 14 are also secured to the frame 12, either directly or indirectly through the bulkhead component 16. The storage drive supports 14 are so placed in a fixed relationship relative to the bulkhead component 16. The storage drive supports 14 are illustratively represented as a plurality of horizontal shelves that are located above one another, although it should be understood that each storage drive support 14 may, for example, include a lower shelf, side walls, and an upper panel which jointly define a housing or a slot with a profile corresponding to a profile of one of the SATA storage drives 20, or may be in the form of rails on opposing sides of each SATA storage drive 20. The storage drive supports 14 are all located on the right of the bulkhead component 16, and are spaced from one another the same as the connector openings 42.

The bulkhead connectors 24 are SATA connectors that are inserted partially through the connector openings 42 and mounted to the bulkhead component 16. Each bulkhead connector 24 has a bulkhead connector body 44, first bulkhead connector terminals 46, with respective flexible signal cables 34 and flexible power lines 28 extending therefrom. The bulkhead connector terminals 46 are located in or on the bulkhead connector body 44, and are connected to the flexible signal cables 34 or flexible power lines 28. The bulkhead connector terminals 46 are exposed to the right of the bulkhead component 16, and the flexible signal cables 34 and flexible power lines 28 extend to the left of the bulkhead component 16.

As required by SATA protocol, each flexible signal cable 34 and a respective signal connector 30 interconnects a respective one of the board connectors 26 individually to a respective one of the bulkhead connectors 24 with the signal connector 30 mating with a respective board connector 26.

One of the power cables 38A connects the power supply 36 to the first power connector 40A illustrated at the top. The first power connector 40 at the top also mates with the second power connectors 32A at the top. The second power connector 32A at the top is connected through the flexible power lines 28A at the top to the bulkhead connector 24A at the top. As such, the bulkhead connector 24A at the top is connected to both the power supply 36 and to the electronic board 18.

Another one of the power cables 38B connects the first power connector 40A at the top with the first power connector 40B second from the top. The first power connector 40B second from the top mates with the second power connector 32B second from the top, which is connected through the flexible power line 28B second from the top to the bulkhead connector 24B second from the top. Further ones of the power cables 38 connect subsequent ones of the first power connectors 40 to one another and to further ones of the bulkhead connectors 24.

It can thus be seen that the bulkhead connectors 24 are all connected to be in communication with the electronic board 18, are all connected to the power supply 36, and are all mounted in a fixed relationship relative to the bulkhead component 16, the frame 12, and the storage drive supports 14.

The SATA storage drives 20 may, for example, be hard drives, CD-ROM drives, etc. Each S-ATA storage drive 20 has a respective drive connector 22 on a left side thereof.

With the bulkhead connectors 24 in place, the S-ATA storage drives 20 can be connected thereto. Each S-ATA storage drive 20 is positioned on a respective one of the storage drive supports 14 and moved to the left until the drive connector 22 thereon mates with the first bulkhead connector terminals 46 on a respective bulkhead connector 24. The respective S-ATA storage drive 20 is then connected through the drive connector 22 thereon, one bulkhead connector 24, one of the flexible signal cables 34 and one of the signal connectors 30 to a respective one of the board connectors 26 on the electronic board 18. The respective SATA storage drive 20 is also connected through the drive connector 22 thereon, the same bulkhead connector 24, one of the second power connectors 32, one or more of the power connectors 40, and one or more of the power cables 38 to the power supply 36.

It may be required from time to time to replace one of the SATA storage drives 20. The S-ATA storage drive 20 can be moved to the right so that the drive connector 22 thereon disengages from the bulkhead connector 24. The S-ATA storage drive 20 can then be removed from the storage drive support 14 with the drive connector 20 thereon disengaging from the bulkhead connector 24, and another SATA storage drive (not shown) can be located in place of the removed S-ATA storage drive on the storage drive support 14 and connected to the same bulkhead connector 24. S-ATA protocol allows for hot-swapping of S-ATA storage drives, i.e., while the computer system is switched on, and the structural support provided by the bulkhead component 16 allows for replacement of S-ATA storage drives by inserting new S-ATA storage drives from the right, i.e., without the need for an operator to open the casing and connect the S-ATA storage drive from the left.

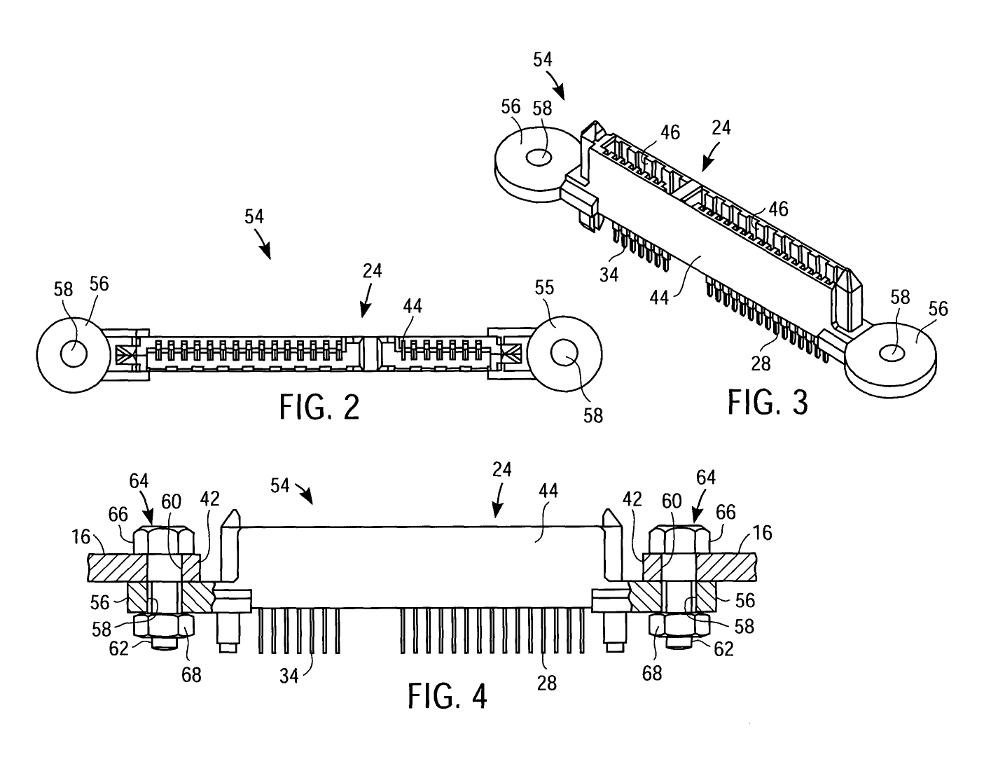

As illustrated in FIGS. 2 to 4, each bulkhead connector 24 forms part of a bulkhead connector assembly 54, which further includes two mounting formations 56 on opposing sides of the bulkhead connector body 44. One side of the bulkhead connector is designated for power and the other side for signals. Each mounting formation 56 has a respective retaining opening 58 formed therein.

With specific reference to FIG. 4, the bulkhead component 16 has a plurality of mounting openings 60 formed therein. Each retaining opening 58 is aligned with a respective mounting opening 60 after the respective bulkhead connector 24 is inserted into a respective connector opening 42. A fastener can then be used to secure the bulkhead connector 24 to the bulkhead component 16. For example, a shaft 62 of a bolt 64 can be inserted through the aligned retaining and mounting openings 58 and 60, with a head 66 on one side thereof, and a nut 68 can be placed on the shaft 62 with the mounting formation 56 and the bulkhead component 16 between the head 66 and the nut 68, to secure the mounting formation 56 to the bulkhead component 16.

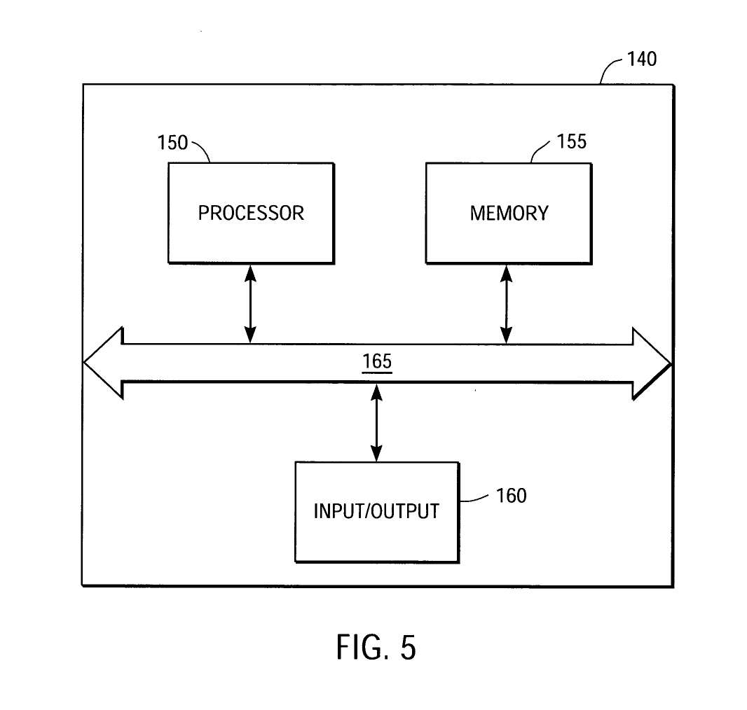

FIG. 5 illustrates further components of a computer system 140 which includes the computer subassembly 10 of FIG. 1. The computer system 140 includes a processor 150, memory 155, and input/output capability 160 coupled to a system bus 165. The memory 155 is configured to store instructions which, when executed by the processor 150, perform the methods described herein. The memory 155 may also store the input and currently edited video content. Input/output 160 provides for the delivery and display of the video contents or portions or representations thereof. Input/output 160 also encompasses various types of computer-readable media, including the SATA storage drives, that is accessible by the processor 150. One of skill in the art will immediately recognize that the term “computer-readable medium/media” further encompasses a carrier wave that encodes a data signal. Input/output and related media 160 store the computer-executable instructions for the operating system and methods of the present invention as well as the video content.

The description of FIG. 5 is intended to provide an overview of computer hardware and other operating components suitable for implementing the invention, but is not intended to limit the applicable environments. It will be appreciated that the computer system 140 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A computer subassembly, comprising:
a frame;
supports secured to the frame for inserting a plurality of information storage drives;
a bulkhead component mounted to the frame;
a plurality of bulkhead connectors mounted on the bulkhead component, each for engaging with a respective drive connector on a respective storage drive when the respective storage drive is inserted;
an electronic board;
a plurality of board connectors on the board, each board connector being connected to a respective bulkhead connector.

2. The computer subassembly of claim 1, wherein the bulkhead connectors and the board connectors are serial ATA connectors.

3. The computer subassembly of claim 2, further comprising:
a plurality of flexible signal cables interconnecting a respective board connector with a respective bulkhead connector.

4. The computer subassembly of claim 3, wherein the flexible cables are serial ATA cables.

5. The computer subassembly of claim 1, wherein the bulkhead component has a plurality of mounting openings therein and each bulkhead connector forms part of a bulkhead connector assembly, each bulkhead connector assembly further including at least one formation on the bulkhead connector thereof, the formation having a retaining opening therein, the computer subassembly further comprising a plurality of fasteners, each fastener being inserted through a respective mounting and a respective retaining opening to mount a respective bulkhead connector assembly to the bulkhead component.

6. The computer subassembly of claim 5, wherein each bulkhead connector assembly includes at least two of said formations on opposing sides of the bulkhead connector thereof.

7. The computer subassembly of claim 1, further comprising:
a plurality of information storage storage drives held by the supports; and
a plurality of drive connectors, each on a respective storage drive and each mating with a respective bulkhead connector.

8. The computer subassembly of claim 1, further comprising:
a computer processor; and
a memory, the board connectors being coupled to the computer processor and the memory.

9. A computer subassembly, comprising:
a frame;
a bulkhead component, mounted to the frame, having a plurality of mounting openings;
a plurality of bulkhead connector assemblies, each including a bulkhead connector and a formation, on the bulkhead connector, defining a retaining opening;
a plurality of fasteners, each fastener being inserted through a respective mounting and a respective retaining opening to mount the respective bulkhead connector assembly to the bulkhead component;
supports on the frame for inserting a plurality of information storage drives, a respective drive connector on each respective storage drive mating with a respective bulkhead connector.

10. The computer subassembly of claim 9, further comprising:
an electronic board;
a plurality of board connectors on the board, each board connector being connected to a respective bulkhead connector.

11. The computer subassembly of claim 9, further comprising:
a plurality of flexible signal cables interconnecting a respective board connector with a respective bulkhead connector.

12. The computer subassembly of claim 9, further comprising:
a plurality of information storage drives held by the supports; and
a plurality of drive connectors, each on a respective storage drive and each mating with a respective bulkhead connector.

13. A computer subassembly, comprising:
a frame;
a bulkhead component mounted to the frame;
a plurality of serial ATA bulkhead connectors mounted on the bulkhead component;
supports secured to the frame;
a plurality of serial ATA storage drives, each inserted on a respective support;
a plurality of serial ATA drive connectors, each mounted to a respective serial ATA storage drive and each being connected to a respective serial ATA bulkhead connector due to insertion of the respective storage drive;
an electronic board;
a plurality of serial ATA board connectors on the board, each serial ATA board connector being individually connected to a respective serial ATA bulkhead connector.

14. The computer subassembly of claim 13, further comprising:
a plurality of flexible signal cables interconnecting a respective board connector with a respective bulkhead connector.

15. The computer subassembly of claim 13, wherein the bulkhead component has a plurality of mounting openings therein and each serial ATA bulkhead connector forms part of a bulkhead connector assembly, each bulkhead connector assembly further including at least one formation on the bulkhead connector thereof, the formation having a retaining opening therein, the computer subassembly further comprising a plurality of fasteners, each fastener being inserted through a respective mounting and a respective retaining opening to mount a respective bulkhead connector assembly to the bulkhead component.

16. The computer subassembly of claim 15, wherein each bulkhead connector assembly includes at least two of said formations on opposing sides of the serial ATA bulkhead connector thereof.

17. A method of constructing a computer subassembly, comprising:
mounting a plurality of bulkhead connectors to a bulkhead component;
connecting each bulkhead connector individually to a respective board connector on an electronic board; and
inserting a plurality of information storage drives on supports, a respective drive connector on each storage drive mating with a respective bulkhead connector on the bulkhead component.

18. The method of claim 17, wherein the bulkhead connectors are mounted to the bulkhead component by inserting fasteners through mounting and retaining openings respectively in the bulkhead component and in formations on each bulkhead connector.

19. The method of claim 17, wherein the bulkhead connectors and the board connectors are serial ATA connectors and the storage drives are serial ATA storage drives.
